(19) United States
(12) Patent Application Publication
(10) Pub. No.: US 2015/0095487 A1
(43) Pub. Date: Apr. 2, 2015

(54) THIRD-PARTY LINK TRACKER SYSTEM AND METHOD

(71) Applicant: TRKSIT, LLC, Hampstead, MD (US)

(72) Inventors: Leslie Nichole Ross KELLY, Hampstead, MD (US); Arsham Mecanic MIRSHAH, Columbia, MD (US)

(73) Assignee: TRKSIT, LLC, Hampstead, MD (US)

(21) Appl. No.: 14/042,324

(22) Filed: Sep. 30, 2013

(51) Int. Cl. H04L 29/08

(52) U.S. Cl. CPC H04L 67/22
USPC 709/224

(57) ABSTRACT

An online user tracker system and methods including a third-party link tracker which tracks online user interactions involving third-party links made available on fourth-party mediums/systems.

Embodiments relate generally to online user tracker systems and methods and, more particularly, to third-party link tracker systems and methods providing the ability track online user interactions involving third-party links made available on fourth-party mediums/systems.

Online groups such as businesses frequently utilize shortened links to direct traffic to third-party sites when sharing informative or relevant content with their users. These shortened links may be posted on their own website as well as on fourth-party mediums/systems such as email, text messaging on a microblogging service such as Twitter, or the fan page of a social networking site, such as Facebook. When a business sends a prospective customer or existing customer to a third-party website via fourth-party mediums/systems, the ability to track the customer's activity to determine behavioral patterns may be diminished because the activity occurs on third- and fourth-party mediums/systems outside the control of the business. Therefore, a need may exist to provide expanded tracking of online user interactions involving third-party links.

One embodiment includes a computer system for tracking third party links, including a processor and a memory coupled to the processor, the memory having stored therein software instructions that, when executed by the processor, cause the processor to perform operations including receiving, at a tracking-enabled server, a new tracked link request from a link originator, the request including a third-party destination link and additional tracking data, the third-party destination link comprising a URL that resolves to a web page hosted on a third-party server; generating, at the tracking-enabled server, a tracked link for the received third-party destination link and the additional tracking data, the tracked link comprising a URL that resolves to the tracking-enabled server; transmitting, from the tracking-enabled server, the tracked link to the link originator; receiving, at the tracking-enabled server, a request from a tracked link visitor for the tracked link URL; storing, at a tracking data store, a tracked link click event indicating the tracked link visitor requested the tracked link; generating, at the tracking-enabled server, a tracking cookie including at least a portion of the additional tracking data; transmitting, from the tracking server, a redirection message including the tracking cookie to the tracked link visitor, the redirection message being configured to cause the tracked link visitor to be redirected to the web page hosted on the third-party server at the third-party destination link URL; receiving, at the tracking-enabled server, a request from the tracked link visitor for another URL, the request including the tracking cookie; associating the tracked link visitor with the previous tracked link click event based on the tracking cookie; storing, at the tracking data store, a return event indicating the tracked link visitor returned to the tracking-enabled server after requesting the tracked link and being redirected to the third-party destination link; and transmitting, to the tracked link visitor, a response including the web page associated with the requested another URL.

Embodiments can also include a method for tracking third-party link interactions, including receiving a request to track a third-party link including additional tracking data associated with the third party link; generating a trackable link based on the third-party link; receiving a request to access the trackable link from a link visitor; tracking, directly, the link visitor; redirecting the link visitor to the third-party link; receiving a request to access a first-party link from the link visitor; and associating, in web analytics data, the first-party link request with the third party link, wherein the response including the web page associated with the requested another URL is customizable based on the additional tracking data associated with the tracked link previously requested by the tracked link visitor.

### BRIEF DESCRIPTION OF DRAWINGS

Embodiments will hereinafter be described in detail below with reference to the accompanying drawings, wherein like reference numerals represent like elements.

FIG. 1 is a functional block diagram of an exemplary embodiment of a third-party link tracker system;

FIG. 2 is a flowchart showing an exemplary method for tracking third-party links;

FIG. 3 is an exemplary embodiment of a user interface page to create tracked links and a confirmation user interface page for creating new tracked links;

FIG. 4 is an exemplary embodiment of a management and tracking user interface page for viewing/editing/deleting existing tracked links;

FIG. 5 is an exemplary embodiment of a reporting user interface page for reporting collected tracking data; and

FIG. 6 is a system-level block diagram of an exemplary embodiment of a third-party link tracker system.

### DETAILED DESCRIPTION

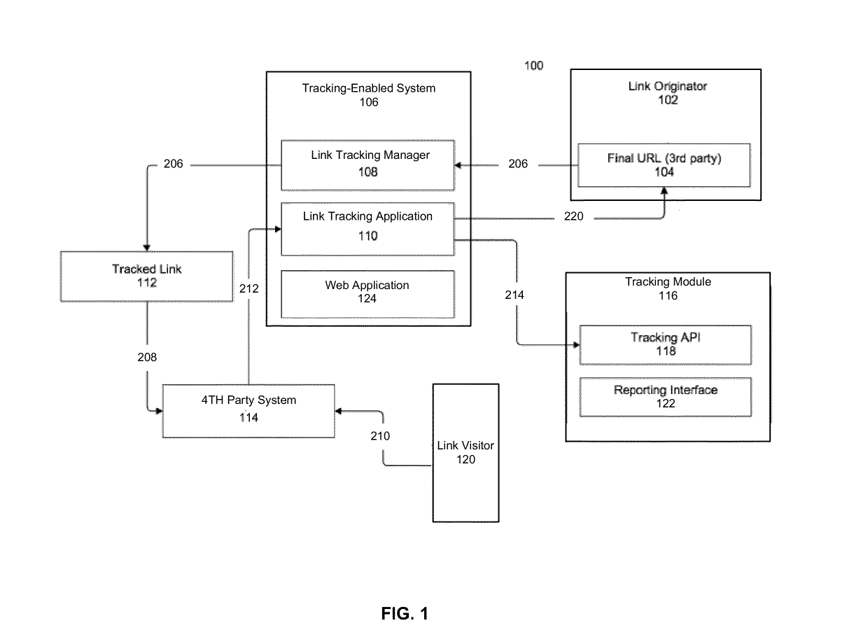

FIG. 1 is a functional block diagram of an exemplary embodiment of a third-party link tracker system. System 100 can include a tracking-enabled system 106 (or “tracking-enabled server”), a fourth-party system 114, a link originator 102, a link visitor 120, and a tracking module 116. Tracking-enabled system 106 can include a link tracking manager 108, a link tracking application 110, and a web application 124. Tracking module 116 can include a tracking application programming interface (API) 118 and a reporting interface 122.

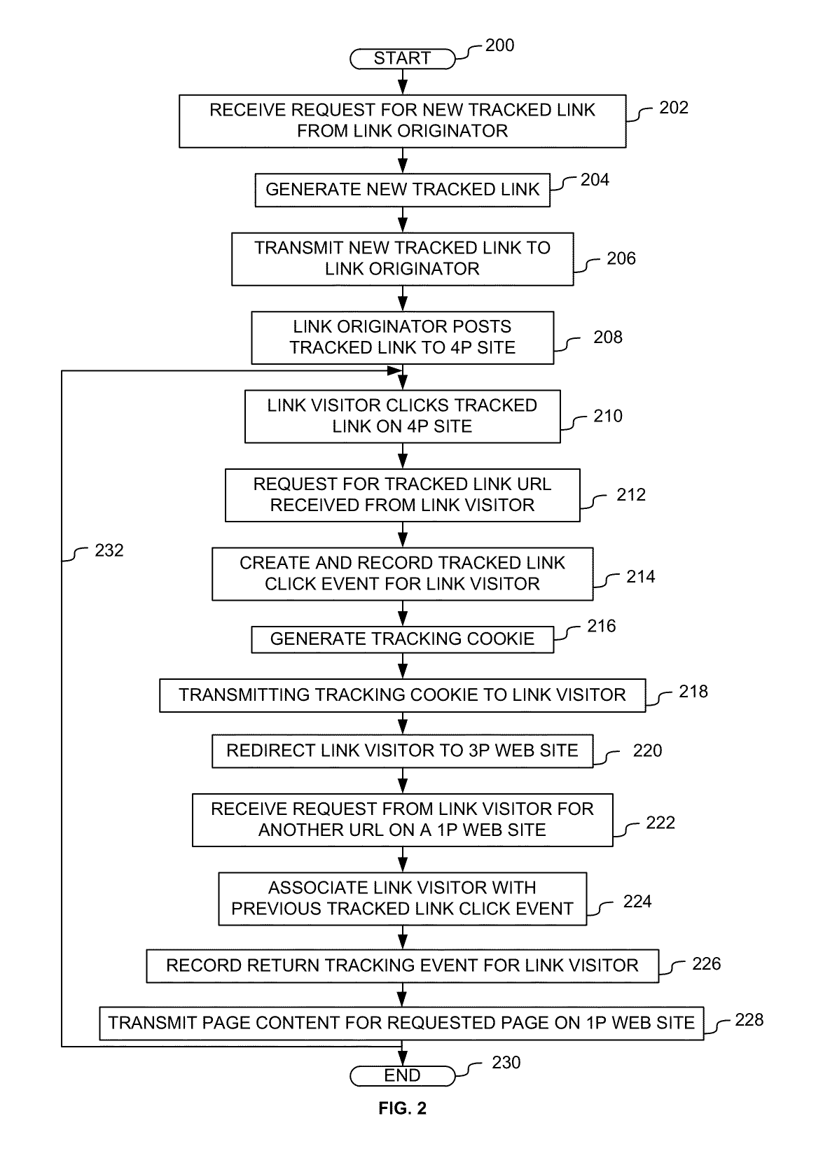

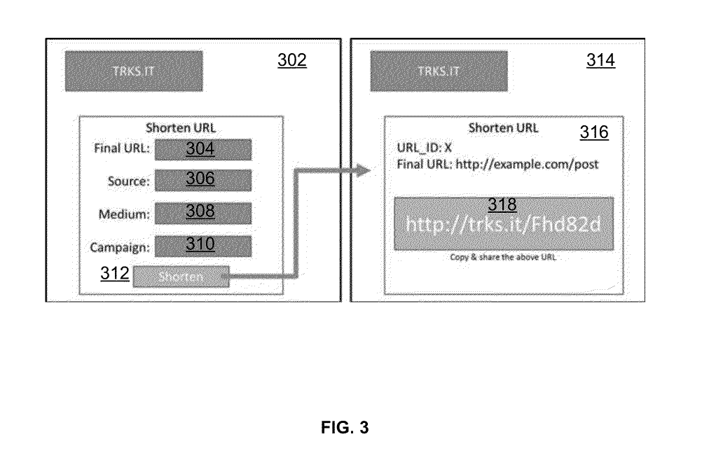

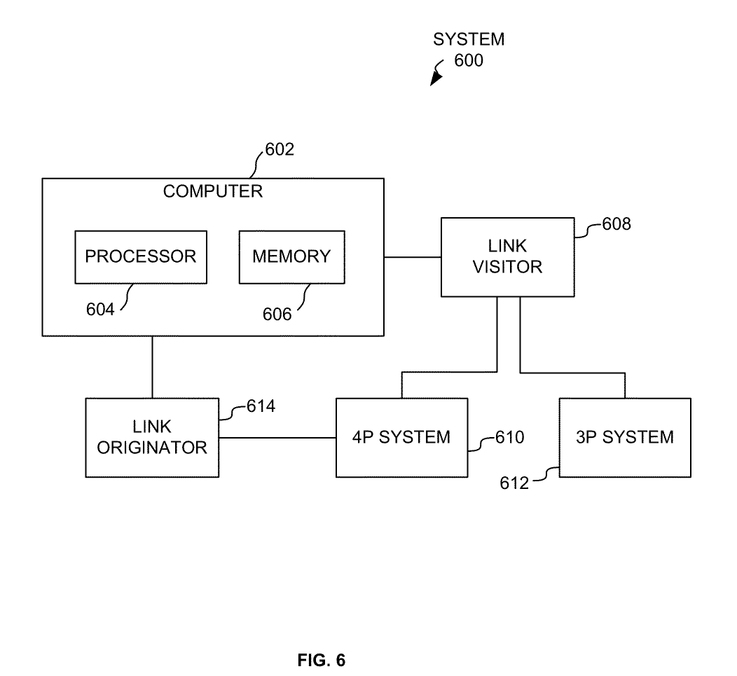

In operation, tracking-enabled system 106 can transmit data to and/or receive data from link originator 102, fourth-party system 114, tracking module 116, and/or link visitor 120 according to the processes shown in FIG. 2 and described in FIGS. 3-6. Fourth-party system 114 can receive data from and/or transmit data to link originator 102 and/or link visitor 120 according to the processes shown in FIG. 2 and the elements, for example, described in FIG. 6.

For example, in operation, tracking-enabled system 106 can receive a final URL (third-party) 104 (or “final third-party link”) and additional tracking data from link originator 102, as indicated by line 206 and described in FIG. 2 below. Link tracking manager 108 can generate a tracked link 112, as indicated by line 206, which can be provided to fourth-party system 114, as indicated by line 208, and made available to link visitor 120. Link visitor 120 can access fourth-party system 114 and request tracked link 112, as indicated by line 210. Tracking-enabled system 106 can receive the request from link visitor 120 via the fourth-party system 114 for tracked link 112, as indicated by line 212, record this event in tracking module 116, as indicated by line 214, and redirect link visitor 120 to the web site corresponding to final third-party link 104, as indicated by line 220.

In some embodiments, link originator 102 can be a client application and/or device operated by an administrative user to create new tracked links. In such embodiments, final third-party link 104 can be a uniform resource locator (URL), or web address, that the administrative user desires to make available for end users such as prospective or existing customers to view via link visitor 120. The URL can point to a third-party web server (not shown), such as an article on Cable News Network (CNN) (cnn.com) or any other third-party site. In some embodiments, link visitor 120 can be a client application and/or device operated by an end user who can click on tracked link 112. For example, in some embodiments, link originator 102 and link visitor 120 can be web browsers or other web clients that can be operated by their respective users.

Tracking-enabled system 106 can host a first-party public website, and can be a top-level domain (TLD) or any sub-domain. A first-party public website is a website associated with the party for which links are being tracked. Web application 124 can be a first-party public website hosted by tracking-enabled system 106.

In some embodiments, link tracking manager 108 creates tracked links and manages previously created tracked links. For example, link tracking manager 108 can create tracked link 112 based on final third-party link 104 included in a request received (206) from link originator 102. Tracked link 112 is a URL hyperlink that can be generated (206) by link tracking manager 108. In some embodiments, link tracking manager 108 creates tracked link 112 as a short link having fewer characters than the original final third-party link 104. In embodiments, tracked link 112 can be shared (208) on any medium where URL hyperlinks may be shared (e.g., email, social media, print collateral, etc.) including fourth-party system 114 which can be a system providing any medium where URL hyperlinks may be shared.

In some embodiments, tracked link 112 comprises a URL that resolves to tracking-enabled system 106. In such embodiments, link visitors, such as link visitor 120, requesting tracked link 112 are first sent to tracking-enabled system 106, which can then begin directly tracking the link visitors using one or more tracking methods, such as a tracking cookie, a tracking script, or any other tracking method. In such embodiments, because requests for tracked link 112 resolve to tracking-enabled system 106, no tracking code/script is required to be hosted on fourth-party system 114 to facilitate the tracking of link visitor 120's request for tracked link 112.

Tracking module 116 can track the properties and activities of online visitors, such as link visitor 120. For example, tracking module 116 can be a web analytics service provider such as Google Analytics, Omniture, and/or Webtrends. Tracking AP1 118 can provide an interface between tracking-enabled system 106 and tracking module 116, such as an interface using the Hypertext Transfer Protocol (HTTP) or any other network communication protocol.

In some embodiments, link visitor 120 can view tracked link 112 on fourth-party system 114 and, after requesting tracked link 112 (e.g., via a user click), link visitor 120 is first directed to link tracking application 110 and is then redirected to the final destination third-party website at the address of final third-party link 104 (214). Link tracking application 110 can collect tracking data and communicate (212) with tracking module 116 using tracking API 118 to add the desired tracking data to tracking module 116 before or after redirecting link visitor 120.

In some embodiments, when link visitor 120 requests tracked link 112, link tracking application 110 creates a tracking cookie storing tracking data including information such as source, medium and campaign as well as other unique data and transmits the tracking cookie to link visitor 120 before redirecting link visitor 120 to the final destination third-party website at the address of final third-party link 104. The tracking data stored in the tracking cookie can also include the date and time of the request and other information that may already be known about link visitor 120 (e.g., data indicating whether link visitor 120 is already a member of (or has previously visited) web application 124, or indicating that link visitor 120 has never visited web application 124). In such embodiments, the tracking data associated with link visitor 120's visit to final third-party link 104 is passed into tracking module 116, such as a web analytics service, marketing automation or CRM software, to preserve the originating source of link visitor 120 and the associated tracking data. In such embodiments, when a user returns to web application 124 after clicking tracked link 112, the tracking data including originating source, medium and campaign information can be used to provide dynamic or unique content to the user based on the tracking data.

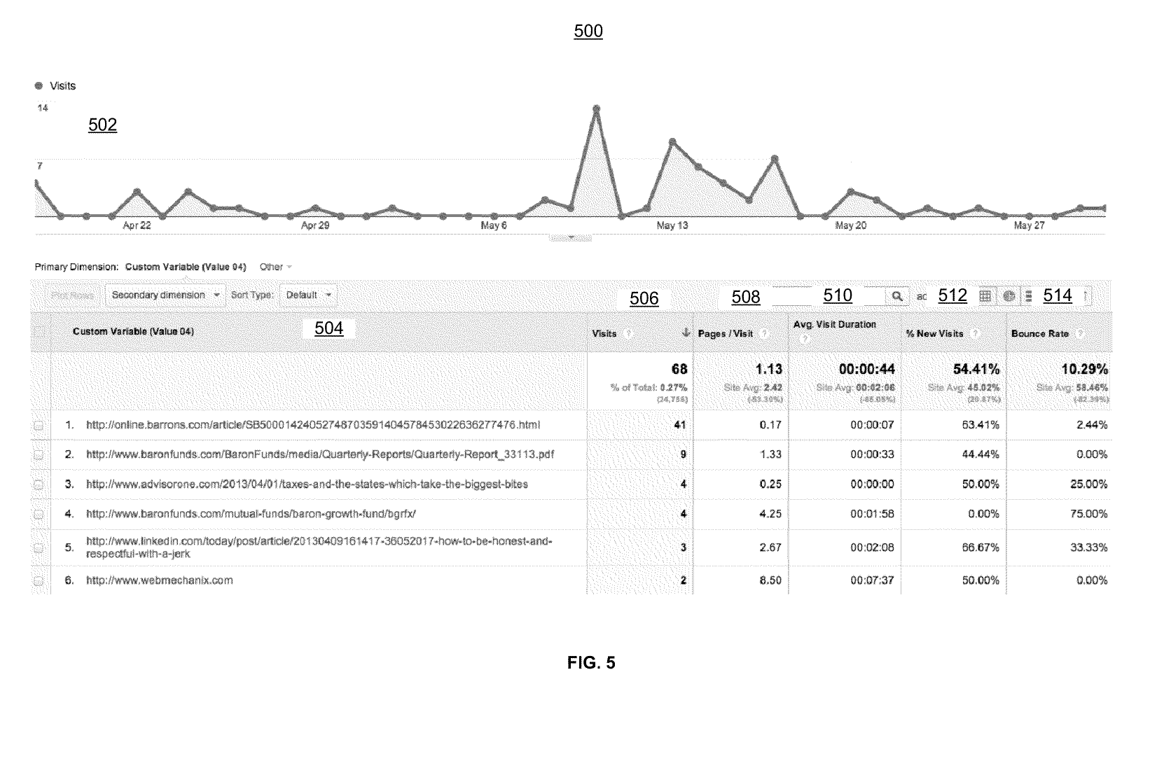

Reporting interface 122 can be a user interface providing end users of third-party link tracker system 100 relevant metrics relating to the collected tracking data. For example, reporting interface 122 can be a Google Analytics interface as shown in FIG. 5.

It will be appreciated that tracking-enabled system 106 can comprise one or more servers capable of providing online access to a first-party public web site (such as web application 124), link tracking manager 108, and link tracking application 110. For example, tracking-enabled server 106 can be a computer configured with a web server such as the Apache HTTP Server. In some embodiments, web application 124 can include a web application, web application framework, or content management system (CMS), such as Wordpress, Drupal, Joomla, etc. In some such embodiments, link tracking manager 108 and link tracking application 110 can be configured as plugins to the web application framework or CMS. Tracking module 116 can also be configured as a plugin and can be configured to store tracking information locally and/or integrate with a web analytics provider such as Google Analytics.

FIG. 2 is a flowchart showing an exemplary method for tracking third-party links. Processing begins at 200 and continues to 202.

At 202, a new tracked link request can be received at a tracking-enabled server from a link originator. The tracking-enabled server can be tracking-enabled server 106 and the link originator can be link originator 112 of FIG. 1, above. The request can include a third-party destination link and additional tracking data. The third-party destination link can be final third-party link 104 of FIG. 1. For example, the third-party destination link can be the URL of an article on CNN's website (http://www.cnn.com). Additional tracking data can include source, medium, campaign, and other unique data. Processing continues to 204.

At 204, a tracked link can be generated, at the tracking-enabled server, for the received third-party destination link and the additional tracking data. The tracked link can be tracked link 112 of FIG. 1, and can comprise a URL that resolves to the tracking-enabled server. Processing continues to 206.

At 206, the tracked link can be transmitted, from the tracking-enabled server, to the link originator. Processing continues to 208.

At 208, the tracked link is posted on a web page hosted on a fourth-party server. For example, the link originator can input/post the tracked link to a fourth-party server through the fourth-party server's input/post method. The fourth-party server can then host the tracked link on its platform and/or servers, and display the tracked link to its online audience. For example, a tracked link can be included in a Twitter post which is then hosted by Twitter and made available to the Twitter community. Processing continues to 210.

At 210, a link visitor can click the tracked link on the fourth-party server. For example, a Twitter follower can click the tracked link posted in the example at 208 discussed above. In another example, the link visitor can manually type in a tracked link that had been printed on a post card. Processing continues to 212.

At 212, a request from a tracked link visitor for the tracked link URL can be received at the tracking-enabled server. Because the tracked link URL resolves to the tracking-enabled server, the tracked link visitor connects to the tracking-enabled server when requesting tracked link URL, and the tracking-enabled server is able to use the this connection to provide enhanced tracking of the tracked link visitor (e.g., as described below at 214-218 and 222-228) prior to redirecting the tracked link visitor to the third-party destination link URL. Processing continues to 214.

At 214, a tracked link click event indicating the tracked link visitor requested the tracked link can be created and stored in a tracking data store. Tracking data can include source, medium, campaign, etc. For example, the tracking data can be stored locally, and/or transmitted to a web analytics service provider, such as Google Analytics, Omniture, Webtrends, etc. The additional tracking data including source, medium, campaign, etc., can be transferred to Google Analytics using custom fields, as shown in the exemplary Google Analytics reporting interface provided in FIG. 5. Tracking data can be sent to Google Analytics (or any other tracking platform) using their specified API connections or standard tracking script (or “tracking codes”). The tracking codes can be written in JavaScript, but can use other client-side scripting languages or server-side programming languages as well (such as PHP, ASP, etc.). For example, in some embodiments, Google Analytics JavaScript tracking code can be used in accordance with the Google Analytics API to pass standard and custom tracking data to Google Analytics databases. Processing continues to 216.

At 216, a tracking cookie can be generated at the tracking-enabled server. The tracking cookie can include at least a portion of the additional tracking data. Processing continues to 218.

At 218, the tracking cookie is transmitted, from the tracking server, to the tracked link visitor. Because the link visitor is directed to the tracking-enabled server by the tracked link prior to being redirected, the tracking cookie is a first-party cookie, thereby decreasing the chances that the tracked link visitor will reject the cookie. Processing continues to 220.

At 220, the tracked link visitor is redirected to the web page hosted on the third-party server at the third-party destination link URL. Redirection can be performed server side or client side. For example, the tracked link visitor can be redirected using client-side techniques such as HTTP meta refresh, JavaScript code, and/or any other programming language. Processing continues to 222.

At 222, a request from the tracked link visitor for another URL can be received, at the tracking-enabled server. The request can include the tracking cookie. Processing continues to 224.

At 224, the tracked link visitor can be associated with the previous tracked link click event based on the tracking cookie. Processing continues to 226.

At 226, a return tracking event can be stored in the tracking data store. The return tracking event can indicate that the tracked link visitor returned to the tracking-enabled server (e.g., viewed a page on the first-party website hosted by tracking-enabled server 106) after previously requesting the tracked link and being redirected to the third-party destination link. Processing continues to 228.

At 228, a response including the web page associated with the requested another URL can be transmitted to the tracked link visitor. The response can be customizable based on the additional tracking data associated with the tracked link previously requested by the tracked link visitor. Processing continues to 230, where processing ends.

It will be appreciated that operations 202-228 may be repeated in whole or in part (an example of which is indicated by line 232) to track multiple links and/or multiple link visitors.

In some embodiments, although not shown, remarking lists can be generated that include tracked link visitors recorded at 214. For example, tracked link visitors can be added to standard remarketing lists or they can choose to create a remarketing list for tracked link visitors that have interacted with tracked links.

It will be appreciated that, although not shown, alternative tracking methods can be used in place of the tracking cookie described above to track the tracked link visitor. For example, in some embodiments a tracking script can be used to track the tracked link visitor. In some embodiments, the tracked link visitor can be tracked by generating and storing an identifier based on characteristics of the tracked link visitor provided by the visitor when requesting the tracked link URL from the tracking-enabled server (e.g., the characteristics can include User-Agent browser data, geolocation data, network data, mobile device data, operating system data, screen resolution data, flash/java support data, installed/supported plugins data, language data, etc.).

In some embodiments, an API provided by a fourth-party medium can be used to retrieve gender, age, profile IDs and other demographic data if user-authentication of the tracked link visitor had been performed by the fourth-party medium.

FIG. 3 is an exemplary embodiment of a user interface page to create tracked links 302 and a confirmation user interface page 314 for creating new tracked links. User interface 302 can include a final URL 304 input field, a source 306 input field, a medium 308 input field, a campaign input field 310, and a button 312. New tracked link confirmation user interface 314 can include a tracked link URL ID 316 and a tracked link URL 318.

In operation, an end user can enter appropriate information into input boxes 304-310 via an operator selection device and then click button 312 to create a tracked link for final URL 304 with the entered settings for source 306, medium 308, and campaign 310. In some embodiments, source 306, medium 308, and campaign 310 are optional.

If the tracked link is created successfully, new tracked link confirmation user interface 314 user interface can be displayed using a device display to provide the tracked link URL_ID 316 and tracked link URL 318.

In some embodiments, when button 312 is clicked, a database entry can be created to record URL_ID 316, final URL 304, source 306, medium 308, campaign 310, tracked link URL 318 date created and other unique information.

In some embodiments, a dynamic URL can be created using the format: “userdomain.com/socialredirect.asp?url_id=X,” where “X” is URL_ID 316, along with a shortened URL such as “http://trks.it/Fhd82d.” The shortened URL can be presented to the user at tracked link URL 318 to share on fourth-party sites.

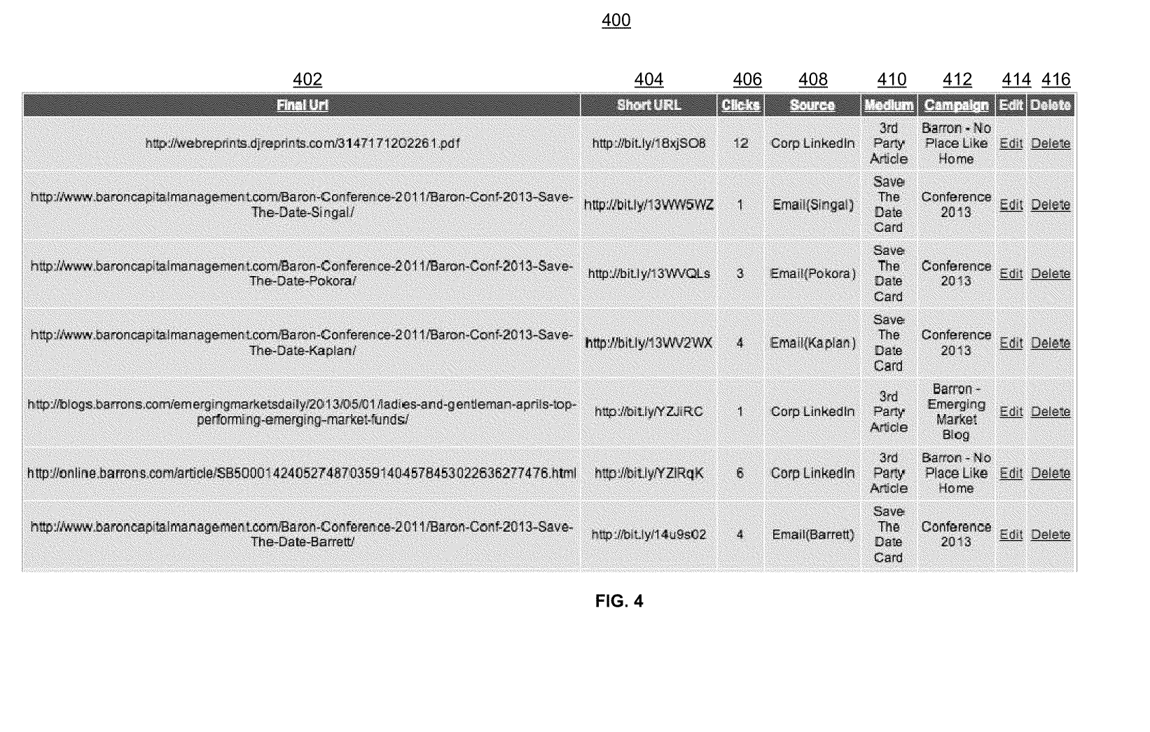

FIG. 4 is an exemplary embodiment of a management and tracking user interface page 400 for viewing/editing/deleting existing tracked links. Management and tracking user interface page 400 can include a table with each row representing a tracked link and the following columns: final URL 402, short URL 404, number of clicks 406, source 408, medium 410, campaign 412, edit link 414, and delete link 416.

In operation, an end user can click edit link 414 to edit an existing tracked link. The end user can click delete link 416 to delete an existing tracked link. In some embodiments, when a user clicks delete link 416, the link is not immediately deleted, but rather merely hidden from being included in the table in page 400 so as to not break the functionality of the redirect for future clicks as the tracked link may have been shared already on a fourth-party system.

FIG. 5 is an exemplary embodiment of a reporting user interface page 500 for reporting collected tracking data and statistics. Reporting user interface page 500 can be generated by a web analytics service, such as Google Analytics. For example, reporting user interface page 500 can include a line graph showing the number of visits per day from users who had previously clicked a tracked third-party link. Reporting user interface page 500 can also include a table with each row representing a tracked link and the following columns: custom variable 504 (or “final third-party link”), visits 506, pages per visit 508, average visit duration 510, percent new visits 512, and bounce rate 514.

In some embodiments, Google Analytics is used as the web analytics service and the tracked link URL can be provided to Google Analytics as a custom variable when the tracking data is recorded, such as when the collected tracking data is transmitted to tracking module 116 of FIG. 1 and described above.

FIG. 6 is a system-level element block diagram of an exemplary embodiment of a third-party link tracker system. System 600 can include a computer 602 that can include a processor 604 and a memory 606. Computer 602 can transmit data to and/or receive data from a link visitor 608. Computer 602 can transmit data to and/or receive data from a link originator 614.

In operation, processor 604 will execute instructions stored on memory 606 that cause computer 602 to transmit data to and/or receive data from link visitor 608 and/or link originator 614 according to the processes shown in FIGS. 1 through 3.

System 600 can be a third-party link tracker system as shown in FIG. 1 and described above. It will be appreciated that computer 602 can have more than one processor.

It will be appreciated that fourth-party system 610 can include any online medium in which links, such as a tracked link to a web page hosted on the third-party system 612, can be posted by a user client, such as link originator 614, and made available to a user, such as link visitor 608, of the online medium. For example, in some embodiments, the fourth-party system 610 can include an online social network, such as Facebook, Google+, MySpace, LinkedIn, etc. In some embodiments the fourth-party system 610 can include a messaging platform such as Twitter, Google Chat, America Online (AOL) Instant Messenger, etc. In some embodiments the fourth-party system 610 can include an online forum or message board, such as web sites that include an online discussion area where users can hold conversations in the form of posted messages.

It will be appreciated that the modules, processes, systems, and sections described above can be implemented in hardware, hardware programmed by software, software instructions stored on a nontransitory computer readable medium or a combination of the above. A third-party link tracker system, for example, can include using a processor configured to execute a sequence of programmed instructions stored on a nontransitory computer readable medium. For example, the processor can include, but not be limited to, a personal computer or workstation or other such computing system, mobile device or mobile phone, iPad™, or any Internet-enabled device that includes a processor, microprocessor, microcontroller device, or is comprised of control logic including integrated circuits such as, for example, an Application Specific Integrated Circuit (ASIC). The instructions can be compiled from source code instructions provided in accordance with a programming language such as Java, C++, C#.net or the like. The instructions can also comprise code and data objects provided in accordance with, for example, the Visual Basic™ language, or another structured or object-oriented programming language. The sequence of programmed instructions and data associated therewith can be stored in a nontransitory computer-readable medium such as a computer memory or transponder device which may be any suitable memory apparatus, such as, but not limited to ROM, PROM, EEPROM, RAM, flash memory, disk drive and the like.

Furthermore, the modules, processes systems, and sections can be implemented as a single processor or as a distributed processor. Further, it should be appreciated that the steps mentioned above may be performed on a single or distributed processor (single and/or multi-core, or cloud computing system). Also, the processes, system components, modules, and sub-modules described in the various figures of and for embodiments above may be distributed across multiple computers or systems or may be co-located in a single processor or system. Exemplary structural embodiment alternatives suitable for implementing the modules, sections, systems, means, or processes described herein are provided below.

The modules, processors or systems described above can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example.

Embodiments of the method and system (or their sub-components or modules), may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a nontransitory computer readable medium).

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the function description provided herein and with a general basic knowledge of the computer programming and network security arts.

Moreover, embodiments of the disclosed method, system, and computer program product can be implemented in software executed on a programmed general purpose computer, a special purpose computer, a microprocessor, or the like.

It is, therefore, apparent that there is provided, in accordance with the various embodiments disclosed herein, computer systems, methods and software for a third-party link tracker.

While the invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of the invention.

What is claimed is:

1. A computer system for tracking third-party links, said computer system comprising:
a processor; and
a memory coupled to the processor, the memory having stored therein software instructions that, when executed by the processor, cause the processor to perform operations including:
receiving, at a tracking-enabled server, a new tracked link request from a link originator, the request including a third-party destination link and additional tracking data, the third-party destination link comprising a URL that resolves to a web page hosted on a third-party server;
generating, at the tracking-enabled server, a tracked link for the received third-party destination link and the additional tracking data, the tracked link comprising a URL that resolves to the tracking-enabled server;
transmitting, from the tracking-enabled server, the tracked link to the link originator;
receiving, at the tracking-enabled server, a request from a tracked link visitor for the tracked link URL;
storing, at a tracking data store, a tracked link click event indicating the tracked link visitor requested the tracked link;
generating, at the tracking-enabled server, a tracking cookie including at least a portion of the additional tracking data;
transmitting, from the tracking server, a redirection message including the tracking cookie to the tracked link visitor, the redirection message being configured to cause the tracked link visitor to be redirected to the web page hosted on the third-party server at the third-party destination link URL;
receiving, at the tracking-enabled server, a request from the tracked link visitor for another URL, the request including the tracking cookie;
associating the tracked link visitor with the previous tracked link click event based on the tracking cookie;
storing, at the tracking data store, a return event indicating the tracked link visitor returned to the tracking-enabled server after requesting the tracked link and being redirected to the third-party destination link; and
transmitting, to the tracked link visitor, a response including the web page associated with the requested another URL,
wherein the response including the web page associated with the requested another URL is customizable based on the additional tracking data associated with the tracked link previously requested by the tracked link visitor.

2. The computer system of claim 1,
wherein the tracked link is posted on a web page hosted on a fourth-party server; and
wherein the request from the tracked link visitor for the tracked link is generated when a user visits the web page hosted on the fourth-party server and clicks on the tracked link.

3. The computer system of claim 1, wherein the additional tracking data includes source, medium and campaign data.

4. The computer system of claim 1, wherein the generating the tracked link comprises generating a short link, the short link comprising fewer characters than the third-party destination link.

5. The computer system of claim 1, wherein the tracking data store is a marketing automation service.

6. The computer system of claim 1, wherein the tracking data store is a web analytics service.

7. The computer system of claim 1, wherein the tracking data store is a customer relationship management (CRM) service.

8. The computer system of claim 1, wherein the tracking cookie is a first-party cookie.

9. A method for tracking third-party link interactions, the method comprising:
receiving a request to track a third-party link including additional tracking data associated with the third-party link;
generating a trackable link based on the third-party link;
receiving a request to access the trackable link from a link visitor;
tracking, directly, the link visitor;
redirecting the link visitor to the third-party link;
receiving a request to access a first-party link from the link visitor; and
associating, in web analytics data, the first-party link request with the third-party link.

10. The method of claim 9,
wherein the trackable link is posted on a web page hosted on a fourth-party server; and
wherein the request to access the trackable link from the link visitor is generated when the link visitor visits the web page hosted on the fourth-party server and selects the trackable link.

11. The method of claim 9, wherein the additional tracking data includes source, medium and campaign data.

12. The method of claim 9, wherein the generating the tracked link comprises generating a short link, the short link comprising fewer characters than the third-party link.

13. The method of claim 12, wherein the fourth-party server comprises at least one of an online social network, an online forum, and an online blog.

14. A non-transitory computer readable medium having stored thereon software instructions that, when executed by a computer, cause the computer to perform operations comprising:
receiving, at a tracking-enabled server, a new tracked link request from a link originator, the request including a third-party destination link and additional tracking data, the third-party destination link comprising a URL that resolves to a web page hosted on a third-party server;
generating, at the tracking-enabled server, a tracked link for the received third-party destination link and the additional tracking data, the tracked link comprising a URL that resolves to the tracking-enabled server;
transmitting, from the tracking-enabled server, the tracked link to the link originator;
receiving, at the tracking-enabled server, a request from a tracked link visitor for the tracked link URL;
storing, at a tracking data store, a tracked link click event indicating the tracked link visitor requested the tracked link;
generating, at the tracking-enabled server, a tracking cookie including at least a portion of the additional tracking data;
transmitting, from the tracking server, the tracking cookie to the tracked link visitor;
redirecting the tracked link visitor to the web page hosted on the third-party server at the third-party destination link URL;
receiving, at the tracking-enabled server, a request from the tracked link visitor for another URL, the request including the tracking cookie;
associating the tracked link visitor with the previous tracked link click event based on the tracking cookie;
storing, at the tracking data store, a return event indicating the tracked link visitor returned to the tracking-enabled server after requesting the tracked link and being redirected to the third-party destination link; and
transmitting, to the tracked link visitor, a response including the web page associated with the requested another URL,
wherein the response including the web page associated with the requested another URL is customizable based on the additional tracking data associated with the tracked link previously requested by the tracked link visitor.

15. The computer system of claim 14,
wherein the tracked link is posted on a web page hosted on a fourth-party server; and
wherein the request from the tracked link visitor for the tracked link is generated when a user visits the web page hosted on the fourth-party server and clicks on the tracked link.

16. The computer readable medium of claim 14, wherein the additional tracking data includes source, medium and campaign data.

17. The computer readable medium of claim 14, wherein the generating the tracked link comprises generating a short link, the short link comprising fewer characters than the third-party destination link.

18. The computer readable medium of claim 17, wherein the fourth-party server comprises at least one of an online social network, an online forum, and an online blog.

19. The computer readable medium of claim 14, wherein the tracking data store is one of a web analytics service, a customer relationship management (CRM) service, and a marketing automation service.

20. The computer readable medium of claim 14, wherein the tracking cookie is a first-party cookie.
